(19) United States
(12) Patent Application Publication
(10) Pub. No.: US 2010/0204862 A1
(43) Pub. Date: Aug. 12, 2010

(54) CONTROL DEVICE FOR VEHICLE

(75) Inventors: Taiyo Uejima, Toyota-shi (JP); Takeshi Kanayama, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi, Aichi-ken (JP)

(21) Appl. No.: 12/679,745

(22) PCT Filed: Sep. 26, 2008
(86) PCT No.: PCT/IB08/02900

§ 371 Date: Mar. 24, 2010

(30) Foreign Application Priority Data
Sep. 28, 2007 (JP) 2007-253666

(51) Int. Cl. G06F 19/00

(52) U.S. Cl. 701/22; 180/65.275

(57) ABSTRACT

In a hybrid vehicle that speed-shifts the output of a motor/generator using an automatic transmission and transmits the speed-shifted output to a drive wheel, a magnet temperature of the motor/generator is estimated, and when the magnet temperature is higher than a reference temperature, an oil pressure command value for engaging or disengaging a brake of the automatic transmission is corrected in a decreasing direction, thereby preventing tie-up shock. When the magnet temperature is lower than the reference temperature, on the other hand, the oil pressure command value for engaging or disengaging the brake of the automatic transmission is corrected in an increasing direction, thereby avoiding racing in the motor/generator.

### BACKGROUND OF THE INVENTION

1. Field of the Invention

The present invention relates to a control device for a vehicle such as a hybrid vehicle having a plurality of drive sources, for example, and more particularly to measures for eliminating the adverse effects of temperature variation on-vehicle control.

2. Description of the Related Art

In recent years, demand for improvements in fuel efficiency and reductions in the amount of exhaust gas discharged from an engine (internal combustion engine) installed in a vehicle have grown from environmental concerns, and hybrid vehicles installed with a hybrid system have been put to practical use as vehicles which satisfy these requirements.

A hybrid vehicle includes an engine such as a gasoline engine or a diesel engine, and an electric motor (for example, a motor/generator or a motor) that generates electric power using engine output, assists the engine output when driven (powered) by electric power stored in a battery, and so on, and employs one or both of the engine and the electric motor as a traveling drive source.

In this type of hybrid vehicle, operating regions (more specifically, driving or stopping) of the engine and the electric motor are controlled on the basis of a vehicle speed and an accelerator opening. For example, in a region where engine efficiency is low, such as during start-up or low-speed travel, the engine is stopped and a drive wheel is driven using the motive power of the electric motor alone. During normal travel, control is performed to drive the engine such that the drive wheel is driven by the motive power of the engine. In a high load region during fully open acceleration or the like, control is performed to supply electric power to the electric motor from the battery so that the motive power of the electric motor is added to the motive power of the engine as auxiliary power.

Conventionally, an automatic transmission that sets an optimum speed-shift ratio between the electric motor and the drive wheel automatically is installed in a vehicle such as the hybrid vehicle described above so that the torque and rotation speed generated by the electric motor are transmitted to the drive wheel appropriately, in accordance with the traveling condition of the vehicle (for example, Japanese Patent Application Publication No. 2006-188213 (JP-A-2006-188213) and Japanese Patent Application Publication No. 2005-264762 (JP-A-2005-264762)). A planetary gear-type transmission that sets a gear stage (a shift stage) using clutches and brakes serving as frictional engagement elements and a planetary gear device is applied as the automatic transmission. For example, two brakes are provided as frictional engagement elements, and switching is performed between a shift stage (a low speed stage, for example) in which a first brake is engaged and a second brake is disengaged and a shift stage (a high speed stage, for example) in which the second brake is engaged and the first brake is disengaged. In this case, a so-called clutch-to-clutch shift for changing the brake combination is performed.

In a typical hybrid vehicle, the output (torque) of the electric motor is controlled by adjusting a current supplied to the electric motor. Therefore, when a shift operation is performed in the transmission while an operation of the electric motor for assisting the driving force or the like is underway, the output of the electric motor is preferably controlled such that the shift operation is performed smoothly, without the occurrence of shift shock.

Incidentally, in a vehicle having an automatic transmission installed between an electric motor and a drive wheel, such as the hybrid vehicle described above, the following problem occurs.

An alternating current synchronous motor (permanent magnet synchronous motor) or the like is typically employed as the electric motor, and the temperature of a rotor magnet in the electric motor varies constantly in accordance with the use condition and the like of the electric motor. When the rotor magnet temperature varies, the capacity of the electric motor varies in accordance with the rotor magnet temperature.

More specifically, when the rotor magnet temperature rises above a reference temperature (75° C., for example), the magnetic force of the rotor magnet decreases, and as a result, an actual output torque tends to become smaller than the output torque that is originally obtained in accordance with a command value relating to the electric motor (the output torque that is obtained from a command value corresponding to the reference temperature). Conversely, when the rotor magnet temperature falls below the reference temperature, the magnetic force increases, and as a result, the actual output torque tends to become larger than the output torque that is originally obtained in accordance with the command value relating to the electric motor (the output torque that is obtained from a command value corresponding to the reference temperature).

When a shift operation is performed in the aforesaid automatic transmission in this situation, the shift operation is performed in the automatic transmission in a state where an output torque diverging from an appropriate output torque is received from the electric motor, and therefore the following problems may occur.

(When the Rotor Magnet Temperature is Higher than the Reference Temperature)

When the rotor magnet temperature is higher than the reference temperature, the actual output torque of the electric motor decreases, and therefore, when a shift operation is performed in the automatic transmission in this situation, the torque capacity of the brake (or clutch) provided in the automatic transmission as a frictional engagement element becomes excessive in relation to the output torque of the electric motor. In other words, an engaging force of the brake becomes excessive in relation to the output torque of the electric motor. As a result, the respective engaging forces of the brake that is engaged before the start of the shift operation and the brake that will be engaged at the end of the shift operation increase beyond an optimum engaging force relative to the output torque of the electric motor during the shift, leading to a so-called tie-up in which an interlocked state occurs temporarily in the interior of the automatic transmission. When a tie-up occurs, shift shock (tie-up shock) is generated in the vehicle during the shift, causing passengers to experience an unpleasant sensation.

FIG. 14 shows a motor rotation speed, an output shaft torque of the automatic transmission, and a brake oil pressure command value of the automatic transmission (the solid line indicates an oil pressure command value relating to the engagement side brake, while the broken line indicates an oil pressure command value relating to the disengagement side brake) when the rotor magnet temperature is higher than the reference temperature. As shown in FIG. 14, tie-up shock, during which the output shaft torque of the automatic transmission decreases rapidly and greatly, occurs at the shift timing.

(When the Rotor Magnet Temperature is Lower than the Reference Temperature)

When the rotor magnet temperature is lower than the reference temperature, the actual output torque of the electric motor increases, and therefore, when a shift operation is performed in the automatic transmission in this situation, the torque capacity of the brake (or clutch) provided in the automatic transmission as a frictional engagement element becomes insufficient in relation to the output torque of the electric motor. In other words, the engaging force of the brake becomes too small in relation to the output torque of the electric motor. As a result, so-called load slip occurs with respect to the electric motor such that during the shift, the rotation speed of the electric motor may rise rapidly (race). When racing occurs in the electric motor in this manner, a large load acts on a driving part and a sliding part of the electric motor, and as a result, the life of the electric motor is shortened.

FIG. 15 shows the motor rotation speed, the output shaft torque of the transmission, and the brake oil pressure command value of the automatic transmission (the solid line indicates an oil pressure command value relating to the engagement side brake, while the broken line indicates an oil pressure command value relating to the disengagement side brake) when the rotor magnet temperature is lower than the reference temperature. As shown in FIG. 15, the rotation speed of the electric motor rises rapidly at the shift timing.

Note that variation in the output torque caused by temperature variation is not limited to the alternating current synchronous motor described above, and occurs similarly in an induction-type electric motor. More specifically, in this type of electric motor, an electric resistance value of a conductor increases as the temperature increases, leading to a reduction in capacity. In other words, similarly to the case described above, when the temperature of the electric motor increases beyond a reference temperature, the actual output torque becomes smaller than the output torque that is originally obtained in accordance with a command value relating to the electric motor. Conversely, when the temperature of the electric motor falls below the reference temperature, the actual output torque becomes larger than the output torque that is originally obtained in accordance with the command value relating to the electric motor.

Furthermore, the output torque varies due to temperature variation in the internal combustion engine as well as the electric motor. In other words, if the temperature of the internal combustion engine varies, the output torque also varies, even when an intake air amount and a fuel injection amount remain constant. More specifically, when the temperature of the internal combustion engine is low (immediately after a cold start, for example), the viscosity of a lubricating oil is high, creating agitation resistance and so on which cause the output torque to decrease. When warm-up of the internal combustion engine is complete, on the other hand, i.e. when the temperature of the internal combustion engine is comparatively high, the agitation resistance decreases, leading to an increase in the output torque.

In this type of vehicle, the output torque of the drive sources varies according to temperature (the aforementioned rotor magnet temperature, the temperature of the internal combustion engine itself, and so on), and therefore situations in which control cannot be performed appropriately (for example, situations in which a shift operation cannot be performed appropriately in the transmission) may arise as a result.

### SUMMARY OF THE INVENTION

The present invention provides a control device for a vehicle, which is capable of eliminating the adverse effects of variation in the temperature of a drive source such as an electric motor or ambient temperature variation on vehicle control.

According to the present invention, a control operation is performed to recognize output torque variation caused by variation in the temperature of a drive source such as an electric motor or ambient temperature variation, and subject the torque capacity of a frictional engagement element of a transmission to correction or the like in accordance with this variation to ensure that problems caused by variation in the output torque do not arise.

A first aspect of the present invention relates to a control device for a vehicle having an electric motor that outputs a driving force for travel, a transmission that is provided on a power transmission path extending from the electric motor to a drive wheel and performs a shift operation by modifying an engagement state of a frictional engagement element, and a transmission control portion that controls the shift operation of the transmission. The control device for a vehicle is provided with: a temperature recognizing portion that estimates or detects a temperature of the electric motor; and a shift operation correcting portion that corrects a control amount of the shift operation performed in the transmission by the transmission control portion, on the basis of the temperature of the electric motor estimated or detected by the temperature recognizing portion.

According to this constitution, even when the capacity of the electric motor varies due to temperature variation in the electric motor itself, a shift operation can be performed in the transmission in accordance with this situation. More specifically, in the case of a permanent magnet synchronous motor, the magnetic force of the magnet varies in accordance with temperature variation. Hence, when the magnet temperature increases, the output torque tends to fall, and when the magnet temperature decreases, the output torque tends to rise. Similarly, in the case of an induction-type motor, the electric resistance of a conductor varies in accordance with temperature variation. Hence, when the temperature increases, the output torque tends to fall, and when the temperature decreases, the output torque tends to rise. When a shift operation is performed in the transmission with reduced output torque, the torque capacity of the frictional engagement elements provided in the transmission becomes excessive in relation to the output torque of the electric motor, leading to the possibility of tie-up shock. Conversely, when a shift operation is performed in the transmission with increased output torque, the torque capacity of the frictional engagement elements provided in the transmission becomes insufficient in relation to the output torque of the electric motor, leading to the possibility of a rapid increase (racing) in the rotation speed of the electric motor.

According to the present invention, the control amount of the shift operation performed in the transmission is corrected in accordance with variation in the output torque of the electric motor resulting from temperature variation, and therefore tie-up shock and racing of the electric motor rotation speed can be avoided.

The temperature recognizing portion may estimate or detect a temperature of a magnet provided in the electric motor. In so doing, a shift operation corresponding to the output torque, which varies in accordance with the magnet temperature of a permanent magnet synchronous motor, can be performed in the transmission.

The shift operation correcting portion may correct the torque capacity of the frictional engagement element during modification of the engagement state of the frictional engagement element.

The following method may be used to correct the torque capacity in this case. The torque capacity of the frictional engagement element during modification of the engagement state of the frictional engagement element may be corrected such that the torque capacity decreases as the temperature of the electric motor, estimated or detected by the temperature recognizing portion, increases above a predetermined reference temperature. When the engagement state of the frictional engagement element is modified by a supply of oil pressure, the shift operation correcting portion may reduce the torque capacity of the frictional engagement element by correcting an oil pressure value supplied to the frictional engagement element in a decreasing direction.

Conversely, the torque capacity of the frictional engagement element during modification of the engagement state of the frictional engagement element may be corrected such that the torque capacity increases as the temperature of the electric motor, estimated or detected by the temperature recognizing portion, decreases below the predetermined reference temperature. When the engagement state of the frictional engagement element is modified by a supply of oil pressure, the shift operation correcting portion may increase the torque capacity of the frictional engagement element by correcting the oil pressure value supplied to the frictional engagement element in an increasing direction. Note that here, the predetermined reference temperature indicates the temperature of the electric motor in a steady driving state, and is set at 75° C., for example. The reference temperature is not limited to this value.

By correcting the torque capacity of the frictional engagement element in accordance with the temperature of the electric motor in this manner, tie-up shock and racing of the electric motor rotation speed can be avoided, enabling an improvement in practical utility.

Further, when the frictional engagement element is constituted by an electromagnetic clutch, the shift operation correcting portion may correct the torque capacity of the frictional engagement element by correcting a voltage value for activating the electromagnetic clutch.

Hence, when the frictional engagement element is constituted by an electromagnetic clutch, rather than being limited to a frictional engagement element whose engagement state is modified by an oil pressure supply, similar actions to the various aspects described above are obtained, and therefore tie-up shock and racing of the electric motor rotation speed can be avoided.

In addition to the torque capacity correction operation performed on the frictional engagement element by the shift operation correcting portion described above, the following constitution may be employed to perform further correction (additional correction). Specifically, a frictional contact surface temperature recognizing portion that estimates or detects a surface temperature of a frictional contact surface of the frictional engagement element, and a shift operation additional correcting portion that corrects a command value of the torque capacity of the frictional engagement element during modification of the engagement state of the frictional engagement element such that the command value increases as the surface temperature of the frictional contact surface, estimated or detected by the frictional contact surface temperature recognizing portion, increases above a predetermined reference temperature, may also be provided.

Further, a frictional contact surface temperature recognizing portion that estimates or detects a surface temperature of a frictional contact surface of the frictional engagement element, and a shift operation additional correcting portion that corrects a command value of the torque capacity of the frictional engagement element during modification of the engagement state of the frictional engagement element such that the command value decreases as the surface temperature of the frictional contact surface, estimated or detected by the frictional contact surface temperature recognizing portion, decreases below a predetermined reference temperature, may also be provided.

By correcting the torque capacity command value of the frictional engagement element in accordance with the surface temperature of the frictional contact surface of the frictional engagement element as well as correcting the torque capacity of the frictional engagement element in accordance with the temperature of the electric motor, a shift operation can be performed in the transmission more accurately and at an optimum torque capacity. Note that the reason for increasing the torque capacity command value of the frictional engagement element as the surface temperature of the frictional contact surface increases above the predetermined reference temperature is that when the surface temperature of the frictional contact surface increases, frictional resistance upon contact with the frictional contact surface of a partner side decreases in comparison with a case in which the surface temperature is low, and as a result, a situation in which the torque capacity becomes insufficient relative to the output torque of the drive source may arise. In other words, by increasing the torque capacity command value of the frictional engagement element, the adverse effects of an increased surface temperature on the frictional contact surface are eliminated.

A second aspect of the present invention relates to a control device for a vehicle having a drive source that outputs a driving force for travel, a transmission that is provided on a power transmission path extending from the drive source to a drive wheel and performs a shift operation by modifying an engagement state of a frictional engagement element, and transmission control portion that controls the shift operation of the transmission. The control device for a vehicle is provided with: a temperature recognizing portion that estimates or detects a temperature of the drive source; and a shift operation correcting portion that corrects a control amount of the shift operation performed in the transmission by the transmission control portion, on the basis of the temperature of the drive source estimated or detected by the temperature recognizing portion.

In this case, the drive source is an internal combustion engine, and the temperature recognizing portion may detect a cooling water temperature or a lubricating oil temperature of the internal combustion engine.

The shift operation correcting portion may correct a torque capacity of the frictional engagement element during modification of the engagement state of the frictional engagement element such that the torque capacity decreases as the temperature of the internal combustion engine, estimated or detected by the temperature recognizing portion, decreases below a predetermined warm-up operation completion temperature.

Further, the shift operation correcting portion may correct a torque capacity of the frictional engagement element during modification of the engagement state of the frictional engagement element such that the torque capacity increases as the temperature of the internal combustion engine, estimated or detected by the temperature recognizing portion, increases above a predetermined warm-up operation completion temperature.

In an internal combustion engine, when the temperature of the internal combustion engine is comparatively low, for example immediately after a cold start, the viscosity of a lubricating oil is high, leading to agitation resistance and so on which tend to cause the output torque to decrease. Following warm-up completion in the internal combustion engine, on the other hand, i.e. when the temperature of the internal combustion engine is comparatively high, the output torque tends to rise due to a reduction in the agitation resistance. This aspect takes these points into consideration such that the torque capacity of the frictional engagement element is corrected on the basis of a correlation between the temperature of the internal combustion engine (for example, a temperature recognized from a cooling water temperature and a lubricating oil temperature) and the output torque. Hence, with this aspect also, tie-up shock caused when the torque capacity of the frictional engagement element becomes excessive in relation to the engine output and racing of the internal combustion engine rotation speed caused when the torque capacity of the frictional engagement element becomes insufficient in relation to the engine output can be avoided.

Further, as well as correcting the torque capacity of the frictional engagement element in accordance with the temperature of the internal combustion engine itself, an aspect in which the torque capacity of the frictional engagement element is corrected in accordance with the temperature of intake air aspirated into the internal combustion engine is also within the technical scope of the present invention. More specifically, a third aspect of the present invention relates to a control device for a vehicle having an internal combustion engine that outputs a driving force for travel, a transmission that is provided on a power transmission path extending from the internal combustion engine to a drive wheel and performs a shift operation by modifying an engagement state of a frictional engagement element, and a transmission control portion that controls the shift operation of the transmission. The control device for a vehicle is provided with a temperature recognizing portion that detects a temperature of intake air aspirated into the internal combustion engine; and a shift operation correcting portion that corrects a control amount of the shift operation performed in the transmission by the transmission control portion, on the basis of the temperature of the intake air detected by the temperature recognizing portion.

In this case, the shift operation correcting portion may correct a torque capacity of the frictional engagement element during modification of the engagement state of the frictional engagement element such that the torque capacity decreases as the temperature of the intake air detected by the temperature recognizing portion increases above a predetermined temperature.

Further, the shift operation correcting portion may correct a torque capacity of the frictional engagement element during modification of the engagement state of the frictional engagement element such that the torque capacity increases as the temperature of the intake air detected by the temperature recognizing portion decreases below a predetermined temperature.

In an internal combustion engine, the efficiency with which air is charged into a cylinder increases, leading to an increase in output torque, as the intake air temperature falls. Conversely, the air charging efficiency falls, leading to a reduction in output torque, as the intake air temperature rises. In consideration of this point, the torque capacity of the frictional engagement element is corrected on the basis of a correlation between the temperature of the intake air aspirated into the internal combustion engine and the output torque. Hence, tie-up shock caused when the torque capacity of the frictional engagement element becomes excessive in relation to the engine output and racing of the internal combustion engine rotation speed caused when the torque capacity of the frictional engagement element becomes insufficient in relation to the engine output can be avoided.

Note that here, the predetermined intake air temperature is set at 20° C., for example. With this setting, it is possible to realize a state in which the torque capacity of the frictional engagement element is set on the small side during summer, when the air charging efficiency tends to decrease, and the torque capacity of the frictional engagement element is set on the large side during winter, when the air charging efficiency tends to increase, for example. The predetermined intake air temperature is not limited to this value.

Further, an aspect in which a torque command value relating to an electric motor is corrected in accordance with the temperature of the electric motor is also within the technical scope of the present invention. More specifically, a fourth aspect of the present invention relates to a control device for a vehicle having an electric motor that outputs a driving force for travel, and an electric motor control portion that drive-controls the electric motor by outputting a torque command value to the electric motor. The control device for a vehicle is provided with: a temperature recognizing portion that estimates or detects a temperature of the electric motor; and a torque command value correcting portion that corrects the torque command value output by the electric motor control portion, on the basis of the temperature of the electric motor estimated or detected by the temperature recognizing portion.

In this case, the torque command value correcting portion may correct the torque command value such that the torque command value increases as the temperature of the electric motor estimated or detected by the temperature recognizing portion increases above a predetermined temperature.

Further, the torque command value correcting portion may correct the torque command value such that the torque command value decreases as the temperature of the electric motor estimated or detected by the temperature recognizing portion decreases below the predetermined temperature.

According to these specific items, a desired output torque is obtained from the electric motor at all times, regardless of the temperature of the electric motor, and therefore traveling stability in the vehicle and a travel performance that corresponds to a driver request can be obtained.

In the present invention, a control operation is performed to recognize output torque variation caused by variation in the temperature of a drive source such as an electric motor or ambient temperature variation, and subject the torque capacity of a frictional engagement element of a transmission to correction or the like in accordance with this variation to ensure that problems caused by variation in the output torque do not arise. Hence, the adverse effects of temperature-related output torque variation in the electric motor or other drive source can be eliminated, and as a result, tie-up shock during a shift operation and racing of the electric motor rotation speed can be avoided.

### BRIEF DESCRIPTION OF THE DRAWINGS

The foregoing and further features and advantages of the invention will become apparent from the following description of embodiments with reference to the accompanying drawings, wherein like numerals are used to represent like elements, and wherein:

FIG. 1 is a schematic diagram showing a hybrid vehicle according to a first embodiment;

FIG. 2 is a schematic diagram of an automatic transmission installed in the hybrid vehicle;

FIG. 3 is an operation table of the automatic transmission;

FIG. 4 is a view showing a hydraulic control circuit for controlling the automatic transmission;

FIG. 5 is a block diagram showing the constitution of a control system such as an ECU;

FIG. 6 is a view showing an example of a map used to calculate a required torque;

FIG. 7 is a view showing an example of a shift map used during shift control;

FIG. 8 is a view showing a relationship between a rotor magnet temperature and an output torque of a motor/generator;

FIG. 9 is a flowchart showing procedures of a brake oil pressure control operation;

FIG. 10 is a timing chart showing variation in a motor rotation speed, an output shaft torque of the transmission, and an oil pressure command value of the brake when the rotor magnet temperature is higher than a reference temperature;

FIG. 11 is a timing chart showing variation in the motor rotation speed, the output shaft torque of the transmission, and the oil pressure command value of the brake when the rotor magnet temperature is lower than the reference temperature;

FIG. 12 is a schematic diagram showing a hybrid vehicle according to a modified example;

FIG. 13 is a schematic diagram showing a hybrid vehicle according to a second embodiment;

FIG. 14 is a view corresponding to FIG. 10 in a conventional example; and

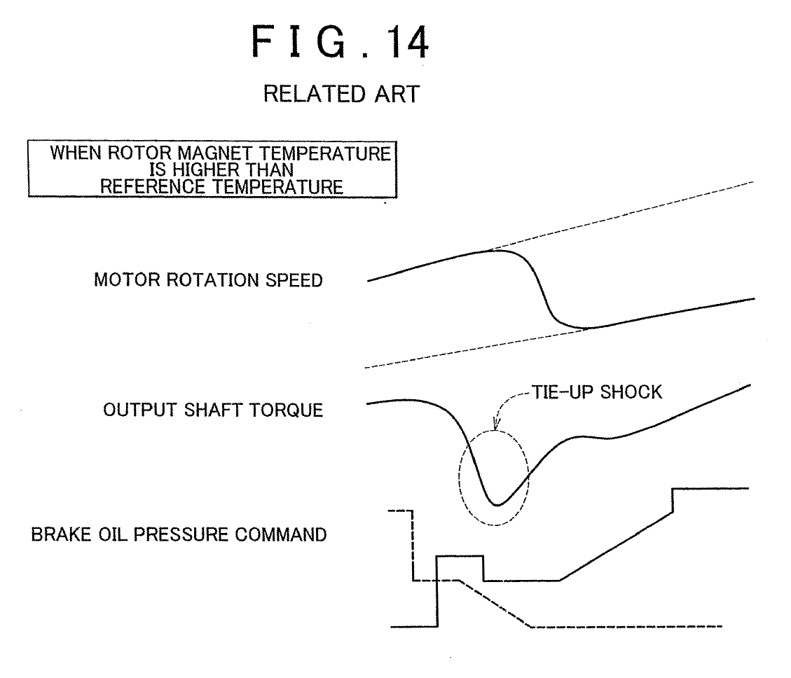

FIG. 15 is a view corresponding to FIG. 11 in a conventional example.

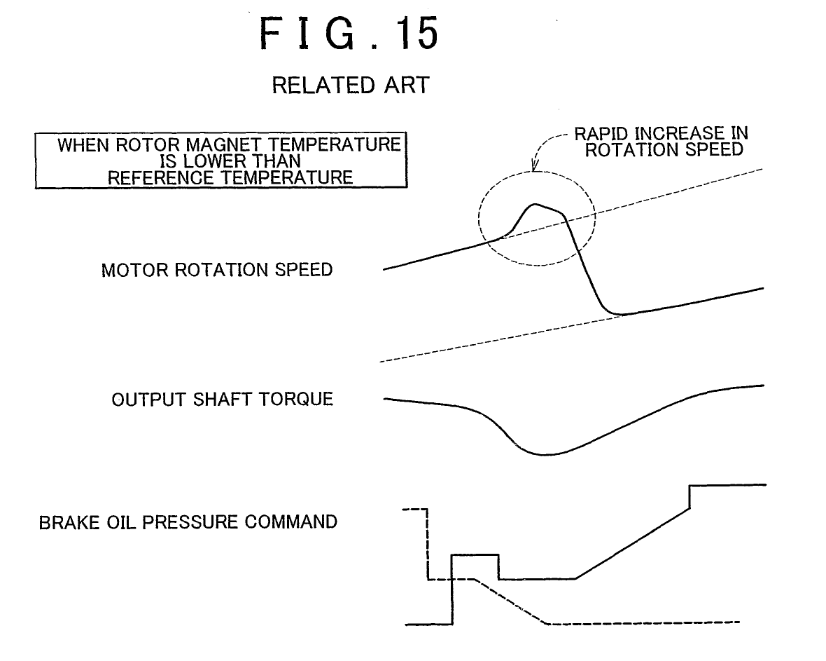

### DETAILED DESCRIPTION OF EMBODIMENTS

Embodiments of the present invention will be described below on the basis of the drawings.

### First Embodiment

This embodiment describes a case in which the present invention is applied to a hybrid vehicle having two motor/generators and structured as an FR (front engine/rear drive) vehicle.

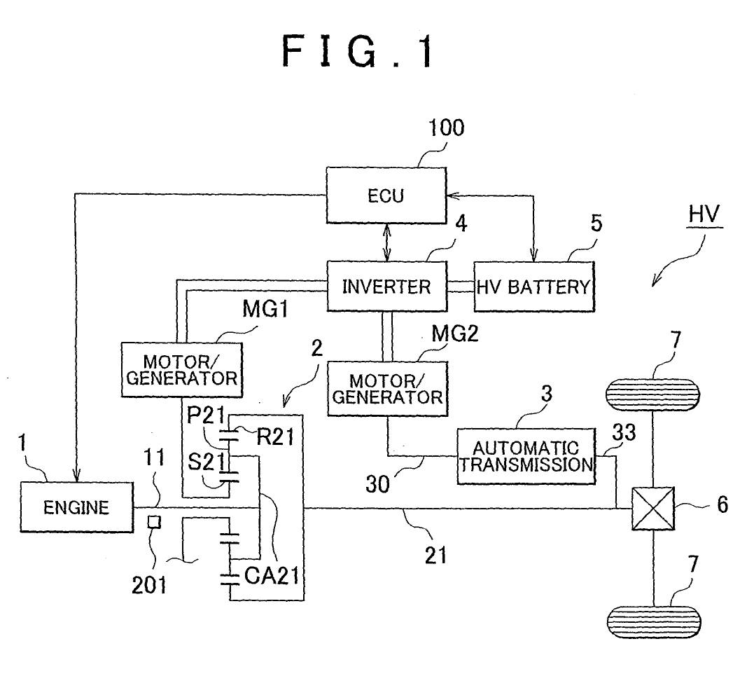

FIG. 1 is a schematic diagram showing an example of a hybrid vehicle HV according to this embodiment.

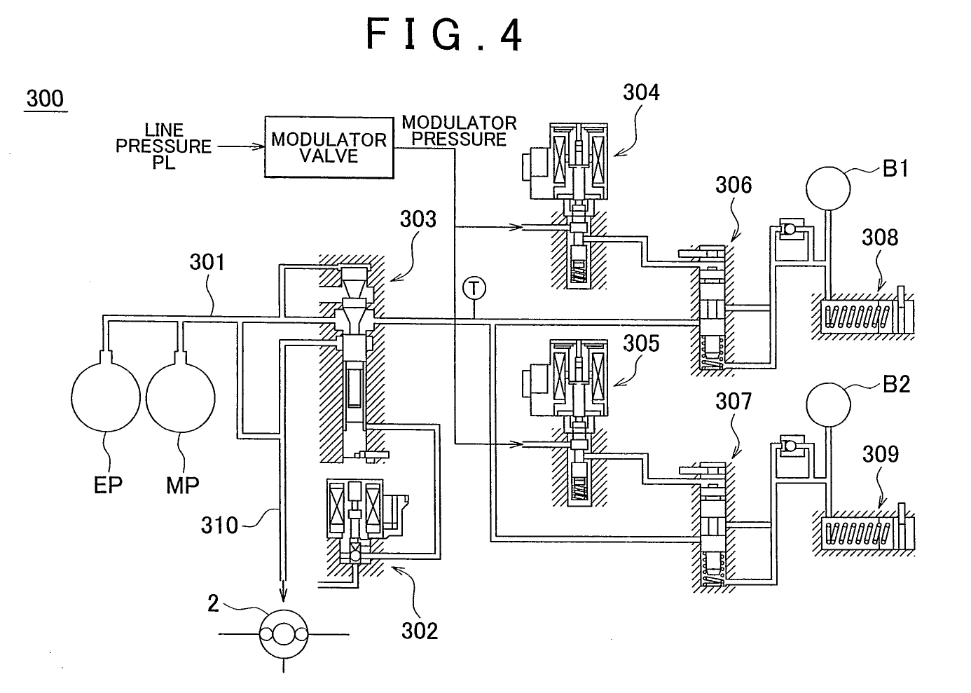

The hybrid vehicle HV includes an engine 1, a first motor/generator MG1, a second motor/generator MG2, a power distribution mechanism 2, an automatic transmission 3, an inverter 4, an HV battery 5, a differential gear 6, drive wheels 7, a hydraulic control circuit 300 (see FIG. 4), an ECU (Electronic Control Unit) 100, and so on.

The engine 1, the respective motor/generators MG1, MG2, the power distribution mechanism 2, the automatic transmission 3, and the ECU 100 will each be described below.

[Engine]

The engine (drive source) 1 is a conventional power device (internal combustion engine) that outputs motive power by burning fuel, such as a gasoline engine or a diesel engine, and is constituted to be capable of controlling operating conditions such as a throttle opening (intake air amount), a fuel injection amount, and an ignition timing. Further, the rotation speed (engine rotation speed) of a crankshaft 11 serving as an output shaft of the engine 1 is detected by an engine rotation speed sensor 201. The engine 1 is drive-controlled by the ECU 100.

[Motor/Generator]

The motor/generators MG1, MG2 are alternating current synchronous motors, and function as both electric motors (drive sources) and power generators. The motor/generators MG1, MG2 are connected to the HV battery 5 via the inverter 4. The inverter 4 is controlled by the ECU 100, and by controlling the inverter 4, the motor/generators MG1, MG2 are set to perform either regeneration or powering (assist). Regenerative power generated at this time is charged to the HV battery 5 via the inverter 4. Further, drive power for driving the motor/generators MG1, MG2 is supplied from the HV battery 5 via the inverter 4. Note that a secondary battery such as a nickel hydrogen battery or a lithium ion battery, a fuel cell, or similar is applied to the HV battery 5. Alternatively, a large capacity capacitor such as an electric double layer capacitor or the like may be used as a storage device instead of the HV battery 5.

[Power Distribution Mechanism]

The power distribution mechanism 2 is constituted by a planetary gear mechanism that includes a sun gear S21 serving as an external gear, a ring gear R21 serving as an internal gear disposed concentrically with the sun gear S21, a plurality of pinion gears P21 that mesh with the sun gear S21 and mesh with the ring gear R21, and a carrier CA21 that carries the plurality of pinion gears P21 so as to be free to spin and revolve, and performs a differential action using the sun gear S21, ring gear R21, and carrier CA21 as rotary elements.

The crankshaft 11 serving as the output shaft of the engine 1 is connected to the carrier CA21 of the power distribution mechanism 2. A rotary shaft of the first motor/generator MG1 is connected to the sun gear S21 of the power distribution mechanism 2. A ring gear shaft 21 is connected to the ring gear R21 of the power distribution mechanism 2. The ring gear shaft 21 is connected to the drive wheels 7 via the differential gear 6. Further, a rotary shaft of the second motor/generator MG2 is connected to the ring gear shaft 21 via the automatic transmission 3.

In the power distribution mechanism 2 having the structure described above, when the first motor/generator MG1 functions as a power generator, power from the engine 1, which is input from the carrier CA21, is distributed to the sun gear S21 side and the ring gear R21 side in accordance with a gear ratio thereof. When the first motor/generator MG1 functions as an electric motor, on the other hand, power from the engine 1, which is input from the carrier CA21, and power from the first motor/generator MG1, which is input from the sun gear S21, are integrated and output to the ring gear R21.

[Automatic Transmission]

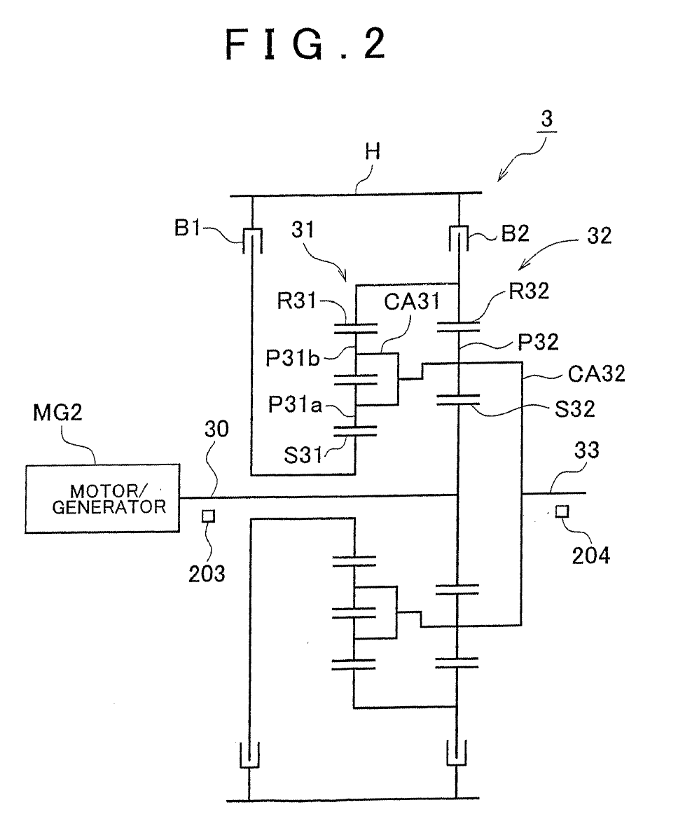

As shown in FIG. 2, the automatic transmission 3 is a planetary gear-type transmission including a double pinion-type first planetary gear mechanism 31, a single pinion-type second planetary gear mechanism 32, two brakes (frictional engagement elements) B1, B2, and so on. An input shaft 30 of the automatic transmission 3 is connected to the rotary shaft of the second motor/generator MG2, and an output shaft 33 thereof is connected to the ring gear shaft (output shaft) 21 (see FIG. 1).

The first planetary gear mechanism 31 includes a sun gear S31 serving as an external gear, a ring gear R31 serving as an internal gear disposed concentrically with the sun gear S31, a plurality of first pinion gears P31a that mesh with the sun gear S31, a plurality of second pinion gears P31b that mesh with the first pinion gears P31a and mesh with the ring gear R31, and a carrier CA31 that connects the plurality of first pinion gears P31a and the plurality of second pinion gears P31b and carries the plurality of first pinion gears P31a and the plurality of second pinion gears P31b so as to be free to spin and revolve. The carrier CA31 of the first planetary gear mechanism 31 is connected integrally to a carrier CA32 of the second planetary gear mechanism 32. The sun gear S31 of the first planetary gear mechanism 31 is connected selectively to a housing H serving as a non-rotary member via the brake B1 such that when the brake B1 is engaged, rotation of the sun gear S31 is prevented.

The second planetary gear mechanism 32 includes a sun gear S32 serving as an external gear, a ring gear R32 serving as an internal gear disposed concentrically with the sun gear S32, a plurality of pinion gears P32 that mesh with the sun gear S32 and mesh with the ring gear R32, and the carrier CA32, which carries the plurality of pinion gears P32 so as to be free to spill and revolve. The sun gear S32 of the second planetary gear mechanism 32 is connected to the input shaft 30, and the carrier CA32 is connected to the output shaft 33. Further, the ring gear R32 of the second planetary gear mechanism 32 is connected selectively to the housing H via the brake B2 such that when the brake B2 is engaged, rotation of the ring gear R32 is prevented.

A rotation speed (input rotation speed Nm) of the input shaft 30 of the automatic transmission 3 constituted as described above is detected by an input shaft rotation speed sensor 203. A rotation speed of the output shaft 33 of the automatic transmission 3 is detected by an output shaft rotation speed sensor 204. A current gear stage of the automatic transmission 3 can be determined on the basis of a rotation speed ratio (output rotation speed/input rotation speed) obtained from output signals of the input shaft rotation speed sensor 203 and the output shaft rotation speed sensor 204.

The automatic transmission 3 is capable of switching between a P range (parking range), an N range (neutral range), a D range (forward travel range), and so on, for example, when a driver operates range switching means such as a shift lever.

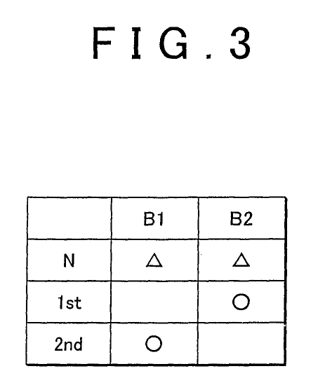

In the automatic transmission 3 described above, the gear stage (shift stage) is set by engaging or disengaging the brakes B1, B2 serving as frictional engagement elements to a predetermined state (a shift operation performed by a transmission control portions). The engagement/disengagement states of the brakes B1, B2 of the automatic transmission 3 are shown in an operation table in FIG. 3. In the operation table of FIG. 3, a circle (∘) indicates engagement and a blank indicates disengagement. A triangle (Δ) indicates that one of the brakes B1, B2 is engaged and the other is disengaged.

In the automatic transmission 3 according to this example, the input shaft 30 (the rotary shaft of the second motor/generator MG2) and the output shaft 33 (the ring gear shaft 21) can be disconnected (a neutral state can be achieved) by disengaging both of the brakes B1, B2. However, the neutral state can also be achieved in the N range by engaging either the brake B2 or the brake B1 such that torque is not generated in the second motor/generator MG2.

Further, a first shift gear stage (1^{st}) is set by engaging the brake B2 and disengaging the brake B1. When the brake B2 is engaged, rotation of the ring gear R32 of the second planetary gear mechanism 32 is fixed, and the carrier CA32, or in other words the output shaft 33, is rotated at low speed by the ring gear R32, the rotation of which is fixed, and the sun gear S32, which is rotated by the second motor/generator MG2.

A second shift gear stage (2^{nd}) is set by engaging the brake B1 and disengaging the brake B2. When the brake B1 is engaged, rotation of the sun gear S31 of the first planetary gear mechanism 31 is fixed, and the carrier CA32 (carrier CA31), or in other words the output shaft 33, is rotated at high speed by the sun gear S31, the rotation of which is fixed, and the sun gear S32 (ring gear R31), which is rotated by the second motor/generator MG2.

In the automatic transmission 3 described above, an upshift from the first speed (1^{st}) to the second speed (2^{nd}) is achieved through clutch-to-clutch shift control in which the brake B2 is disengaged at the same time as the brake B1 is engaged. Further, a downshift from the second speed (2^{nd}) to the first speed (1^{st}) is achieved through clutch-to-clutch shift control in which the brake B1 is disengaged at the same time as the brake B2 is disengaged. Oil pressure during engagement and disengagement of the brakes B1, B2 is controlled by the hydraulic control circuit 300 (see FIG. 4).

The hydraulic control circuit 300 is provided with linear solenoid valves, ON/OFF solenoid valves, and so on, and by controlling excitation and non-excitation of these solenoid valves, the hydraulic circuit can be switched, as a result of which engagement and disengagement of the brakes B1, B2 in the automatic transmission 3 can be controlled. Excitation and non-excitation of the linear solenoid valves and ON/OFF solenoid valves in the hydraulic control circuit 300 are controlled in accordance with a solenoid control signal (instructed oil pressure signal) from the ECU 100.

FIG. 4 shows an outline of the constitution of the hydraulic control circuit 300. As shown in FIG. 4, the hydraulic control circuit 300 is constituted by a mechanical pump MP that is driven by the rotation of the engine 1 and pumps oil (automatic transmission fluid: ATF) to an oil flow passage 301 with a sufficient pumping performance to activate the brakes B1, B2, an electric pump EP that is driven by an inbuilt electric motor, not shown in the drawing, and pumps the oil to the oil flow passage 301 with a required minimum pumping performance for activating the brakes B1, B2, a three-way solenoid valve 302 and a pressure control valve 303 for adjusting a line oil pressure PL of the oil pumped to the oil flow passage 301 from the mechanical pump MP and electric pump EP, and linear solenoid valves 304, 305, control valves 306, 307 and accumulators 308, 309 for adjusting the engaging force of the brakes B1, B2 using the line oil pressure PL. In the hydraulic control circuit 300, the line oil pressure PL can be adjusted by driving the three-way solenoid valve 302 to control the opening and closing of the pressure control valve 303. Further, the engaging force of the brakes B1, B2 can be adjusted by controlling a current applied to the linear solenoid valves 304, 305 to control the opening and closing of the control valves 306, 307, which transmit the line oil pressure PL to the brakes B1, B2. Furthermore, in the hydraulic control circuit 300, surplus oil not used to activate the brakes B1, B2 from the oil pumped by the mechanical pump MP or the electric pump EP and return oil that is discharged from the pressure control valve 303 after being used to activate the brakes B1, B2 are supplied to the power distribution mechanism 2 via an oil flow passage 310 as lubricating oil.

[ECU]

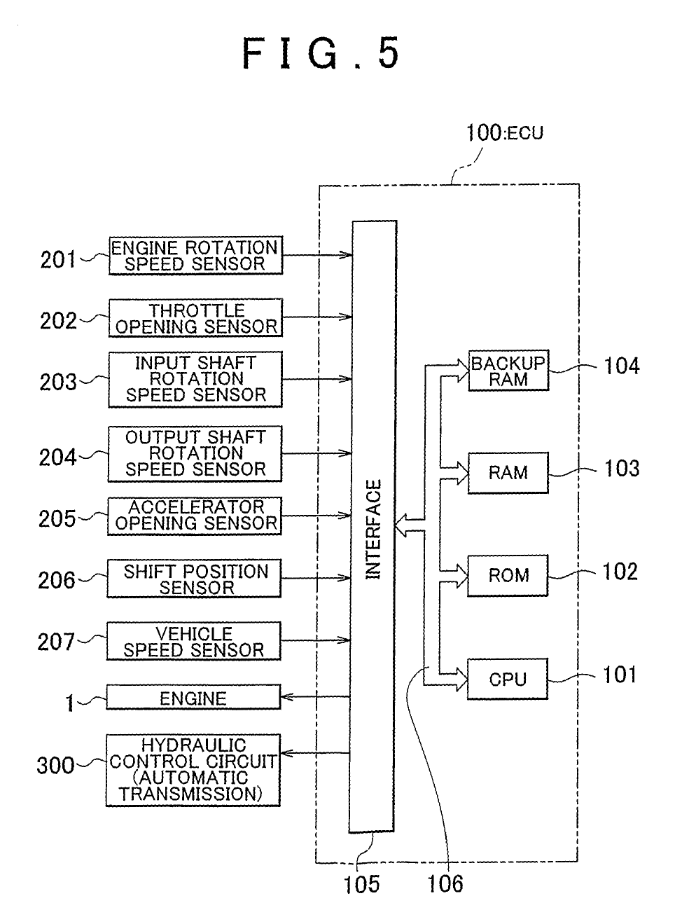

As shown in FIG. 5, the ECU 100 includes a CPU (Central Processing Unit) 101, ROM (Read-Only Memory) 102, RAM (Random Access Memory) 103, backup RAM 104, and so on.

The ROM 102 stores various programs, including a program for controlling a basic operation of the hybrid vehicle HV and a program for executing shift control to set the gear stage of the automatic transmission 3 in accordance with the traveling condition of the hybrid vehicle HV, and so on. The specific content of this shift control will be described below.

The CPU 101 executes calculation processing based on various control programs and maps stored in the ROM 102. The RAM 103 is memory for storing calculation results from the CPU 101, data input from various sensors, and so on temporarily. The backup RAM 104 is nonvolatile memory storing data to be saved when the engine 1 is stopped and so on.

The CPU 101, ROM 102, RAM 103 and backup RAM 104 are connected to each other via a bus 106 and connected to an interface 105.

The aforementioned engine rotation speed sensor 201, a throttle opening sensor 202 for detecting the opening of a throttle valve of the engine 1, the aforementioned input shaft rotation speed sensor 203 and output shaft rotation speed sensor 204, an accelerator opening sensor 205 for detecting the opening of an accelerator pedal, a shift position sensor 206 for detecting the position of a shift lever, a vehicle speed sensor 207 for detecting the vehicle speed of the hybrid vehicle HV, and so on are connected to the interface 105 of the ECU 100, and signals from each of these sensors are input into the ECU 100.

On the basis of the output signals from the various sensors described above, the ECU 100 executes various types of control on the engine 1, such as control of the throttle opening (intake air amount) of the engine 1, fuel injection control, and ignition timing control.

The ECU 100 also outputs a solenoid control signal (brake oil pressure command signal) to the hydraulic control circuit 300 of the automatic transmission 3. The linear solenoid valves 304, 305, control valves 306, 307, and so on of the hydraulic control circuit 300 are controlled on the basis of the solenoid control signal, whereby the brakes B1, B2 are engaged or disengaged to a predetermined state so as to achieve a predetermined gear stage (first speed or second speed).

The ECU 100 also executes “shift control” and “travel control” to be described below.

[Shift Control]

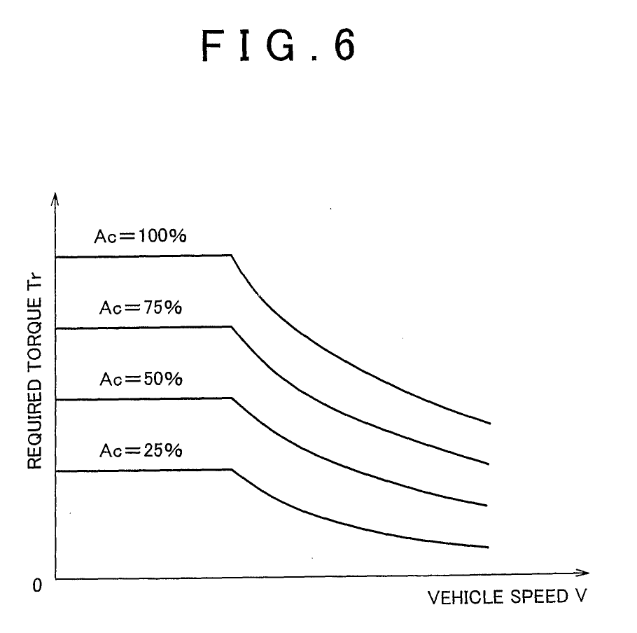

First, the ECU 100 calculates an accelerator opening Ac on the basis of the output signal from the accelerator opening sensor 205, calculates a vehicle speed V on the basis of the output signal from the vehicle speed sensor 207, and then determines a required torque Tr on the basis of the accelerator opening Ac and the vehicle speed V by referring to a map shown in FIG. 6.

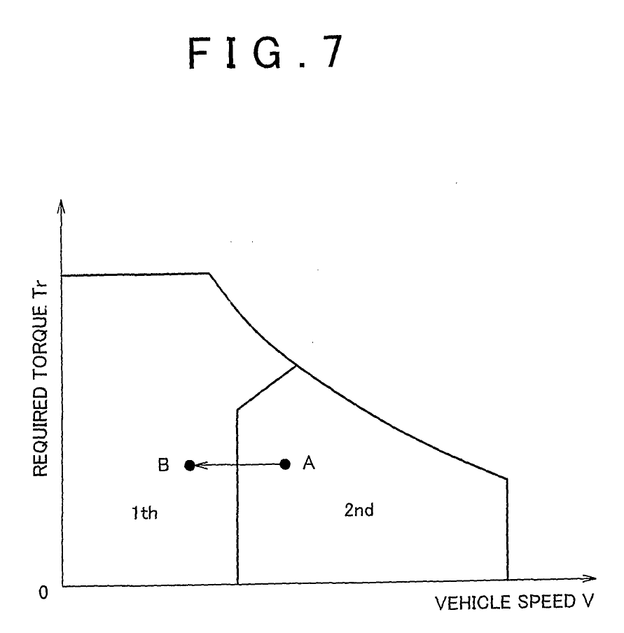

Next, the ECU 100 calculates a target gear stage on the basis of the vehicle speed V and the required torque Tr by referring to a shift map shown in FIG. 7, determines the current gear stage of the automatic transmission 3 on the basis of the rotation speed ratio (output rotation speed/input rotation speed) obtained from the output signals of the input shaft rotation speed sensor 203 and the output shaft rotation speed sensor 204, and compares the target gear stage to the current gear stage to determine whether or not a shift operation is required.

When the determination result indicates that a shift is not required (when the target gear stage and the current gear stage are identical, indicating that the gear stage is set appropriately), the ECU 100 outputs a solenoid control signal (brake oil pressure command signal) for maintaining the current gear stage to the hydraulic control circuit 300 of the automatic transmission 3.

When the target gear stage and current gear stage are different, on the other hand, shift control is performed. For example, when travel is underway with the second speed set as the gear stage of the automatic transmission 3 and the traveling condition of the hybrid vehicle HV changes (the vehicle speed changes, for example) from a point A to a point B in FIG. 7, for example, the target gear stage calculated from the shift map changes to the first speed, and therefore a solenoid control signal (brake oil pressure command signal) for setting the first speed gear stage is output to the hydraulic control circuit 300 of the automatic transmission 3, whereby the brake B1 serving as a frictional engagement element is disengaged at the same time as the brake B2 is engaged. As a result, a shift (a downshift from 2^{nd} to 1^{st}) is performed from the second speed gear stage to the first speed gear stage.

In the map for calculating the required torque, shown in FIG. 6, values obtained by determining the required torque Tr empirically through experiment, calculation, and so on are plotted using the vehicle speed V and the accelerator opening Ac as parameters. This map is stored in the ROM 102 of the ECU 100.

Further, in the shift map shown in FIG. 7, the vehicle speed V and required torque Tr are used as parameters, and two regions (a 1^{st} region and a 2^{nd} region) for determining the appropriate gear stage are set in accordance with the vehicle speed V and required torque Tr. This map is stored in the ROM 102 of the ECU 100. The two regions of the shift map are defined by a shift line (a gear stage switch line).

[Travel Control]

Through similar processing to that described above, the ECU 100 calculates the required torque Tr to be output to the ring gear shaft (output shaft) 21 on the basis of the accelerator opening Ac and the vehicle speed V by referring to the map shown in FIG. 6, and causes the hybrid vehicle HV to travel in a predetermined travel mode by drive-controlling the engine 1 and the motor/generators MG1, MG2 (the inverter 4) such that a required power corresponding to the required torque Tr is output to the ring gear shaft 21.

For example, in a region where engine efficiency is low, such as during start-up or low-speed travel, the engine 1 is stopped and power corresponding to the required power is output to the ring gear shaft 21 from the second motor/generator MG2 via the automatic transmission 3. During normal travel, the engine 1 is driven such that power corresponding to the required power is output from the engine 1, and the rotation speed of the engine 1 is controlled by the first motor/generator MG1 to achieve optimum fuel efficiency.

Further, in a case where torque assist is implemented by driving the second motor/generator MG2, the gear stage of the automatic transmission 3 is set at 1^{st} to increase the torque applied to the ring gear shaft (output shaft) 21 when the vehicle speed V is low, and the gear stage of the automatic transmission 3 is set at 2^{nd} to realize a relative reduction in the rotation speed of the second motor/generator MG2 and a corresponding reduction in loss when the vehicle speed V increases. Thus, efficient torque assist is executed. Travel control is also performed to stop the second motor/generator MG2 and cause the hybrid vehicle HV to travel on torque (direct torque) transmitted directly to the ring gear shaft 21 from the engine 1 via the power distribution mechanism 2 while a reactive force of the engine torque is received by the first motor/generator MG1.

[Brake Oil Pressure Control]

Next, brake oil pressure control, which is a featured operation of this embodiment, will be described. In brake oil pressure control, oil pressure supplied to the brakes B1, B2 by the hydraulic control circuit 300 is controlled to cause the brakes B1, B2 to engage and disengage.

In this embodiment, brake oil pressure control is performed on the basis of a rotor magnet temperature of the second motor/generator MG2.

A condition for setting a pulse signal serving as an output torque command value (to be referred to simply as a command value hereafter) relating to the second motor/generator MG2 is that the rotor magnet temperature reaches 75° C. In other words, when the rotor magnet temperature is 75° C., the command value is set such that the desired output torque is obtained from the second motor/generator MG2. More specifically, the inverter 4 converts a direct current voltage received from a power line into a three-phase alternating current voltage by performing ON/OFF control (switching control) on a power semiconductor switching element in response to a switching control signal from the ECU 100, and outputs the converted three-phase alternating current voltage to the second motor/generator MG2. As a result, the second motor/generator MG2 is drive-controlled to generate output torque corresponding to the command value. The command value relating to the second motor/generator MG2 is set such that the appropriate output torque required of the second motor/generator MG2 is obtained when the rotor magnet temperature is assumed to be 75° C. In other words, as long as the rotor magnet temperature is maintained at 75° C. (a reference temperature), appropriate output torque is obtained from the second motor/generator MG2 in accordance with the command value.

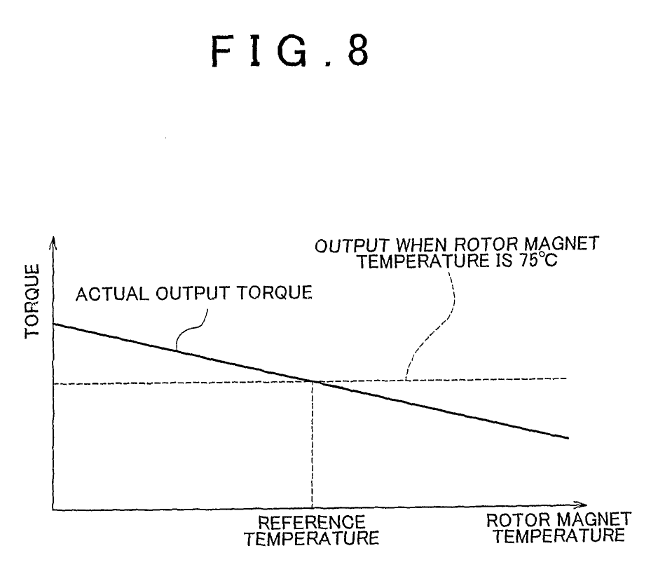

However, the rotor magnet temperature of the second motor/generator MG2 varies constantly in accordance with the use condition and the like of the second motor/generator MG2. When the rotor magnet temperature varies, the capacity of the second motor/generator MG2 varies in accordance with the rotor magnet temperature. More specifically, when the rotor magnet temperature rises above the reference temperature, the actual output torque tends to become smaller than the output torque that is originally obtained in accordance with the command value relating to the second motor/generator MG2. Conversely, when the rotor magnet temperature falls below the reference temperature, the actual output torque tends to become larger than the output torque that is originally obtained in accordance with the command value relating to the second motor/generator MG2. FIG. 8 shows a relationship between a divergence width of the actual output torque relative to the command value and the rotor magnet temperature. As the rotor magnet temperature increases relative to the reference temperature (75° C. in this embodiment), the actual output torque decreases steadily. Conversely, as the rotor magnet temperature decreases relative to the reference temperature (75° C.), the actual output torque increases steadily.

In consideration of these circumstances, in this embodiment the oil pressure applied to the brakes B1, B2 from the hydraulic control circuit 300 is controlled in accordance with the rotor magnet temperature of the second motor/generator MG2. More specifically, as the rotor magnet temperature rises relative to the reference temperature, the oil pressure applied to the brakes B1, B2 from the hydraulic control circuit 300 during a shift operation is set steadily lower, and conversely, as the rotor magnet temperature falls relative to the reference temperature, the oil pressure applied to the brakes B1, B2 from the hydraulic control circuit 300 during a shift operation is set steadily higher (a shift operation correction control performed by a shift operation correcting portion).

To realize this control operation, in this embodiment a rotor magnet temperature estimation map for estimating the rotor magnet temperature of the second motor/generator MG2 is stored in the ROM 102 of the ECU 100. The rotor magnet temperature estimation map shows a relationship between a driving history of the second motor/generator MG2, for example a driving rotation speed per unit time, and an increase in the rotor magnet temperature, and is obtained by plotting values determined empirically through experiment, calculation and so on.

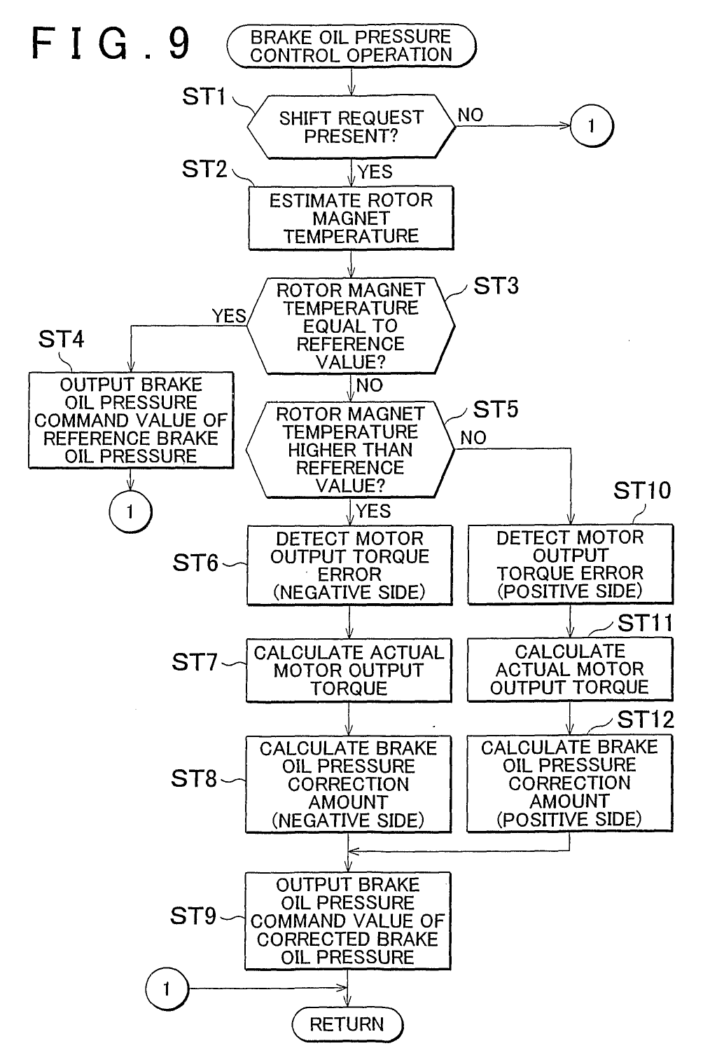

The brake oil pressure control operation will be described below using a flowchart shown in FIG. 9. A brake oil pressure control operation routine shown in FIG. 9 is executed repeatedly in the ECU 100 at predetermined time intervals (of several msec, for example).

First, in a step ST1, a determination is made as to whether or not a shift request has been issued in relation to the automatic transmission 3. In other words, a determination is made as to whether or not the timing for performing a shift operation has arrived while a shift operation is underway in accordance with the shift map shown in FIG. 7. When a shift request has not been issued, a negative determination is made in the step ST1 and the routine is terminated with no further processing.

When a shift request has been issued in relation to the automatic transmission 3 such that an affirmative determination is made in the step ST1, the temperature of a rotor magnet provided in the second motor/generator MG2 is estimated from the driving history of the second motor/generator MG2 using the rotor magnet temperature estimation map described above in a step ST2 (a temperature estimation operation performed by a temperature recognizing portion).

Next, in a step ST3, a determination is made as to whether or not the estimated rotor magnet temperature is equal to a predetermined reference value. Note that here, a determination as to whether or not the estimated rotor magnet temperature is within a reference range may be made. The reference range is set at ±10° C. of the reference temperature (75° C.), for example. The reference range may be set arbitrarily.

When the rotor magnet temperature is determined to be equal to the predetermined reference value in the step ST3 such that an affirmative determination is made, a brake oil pressure command value for obtaining a preset reference brake oil pressure is output to the hydraulic control circuit 300 in a step ST4, and a clutch-to-clutch shift is performed by engaging and disengaging the brakes B1, B2 in accordance with the reference brake oil pressure generated in the hydraulic control circuit 300. In other words, a clutch-to-clutch shift is performed without performing a brake oil pressure correction operation.

On the other hand, when the rotor magnet temperature deviates from the predetermined reference value such that a negative determination is made in the step ST3, the routine advances to a step ST5, where a determination is made as to whether or not the estimated rotor magnet temperature is higher than the reference value.

When the rotor magnet temperature is higher than the reference value such that an affirmative determination is made, the routine advances to a step ST6, where an output torque error (negative side error) is detected by recognizing a temperature-affected divergence amount in the output torque from the relationship between the divergence amount of the actual output torque relative to the command value and the rotor magnet temperature, shown in FIG. 8. The routine then advances to a step ST7, where an actual motor output torque that takes into account this error is calculated. In this case, the actual motor output torque is calculated by subtracting the divergence amount from the output torque obtained when the rotor magnet temperature is equal to the reference temperature (75° C.).

A brake oil pressure correction amount (negative side correction amount) is determined in a step ST8 in accordance with the calculated actual motor output torque, and in a step ST9, a brake oil pressure command value is output to the hydraulic control circuit 300 to obtain the corrected brake oil pressure, and a clutch-to-clutch shift is performed by engaging and disengaging the brakes B1, B2 in accordance with the brake oil pressure generated in the hydraulic control circuit 300. In other words, a clutch-to-clutch shift is performed by engaging and disengaging the brakes B1, B2 in accordance with a lower brake oil pressure than the brake oil pressure used when the rotor magnet temperature is equal to the reference value.

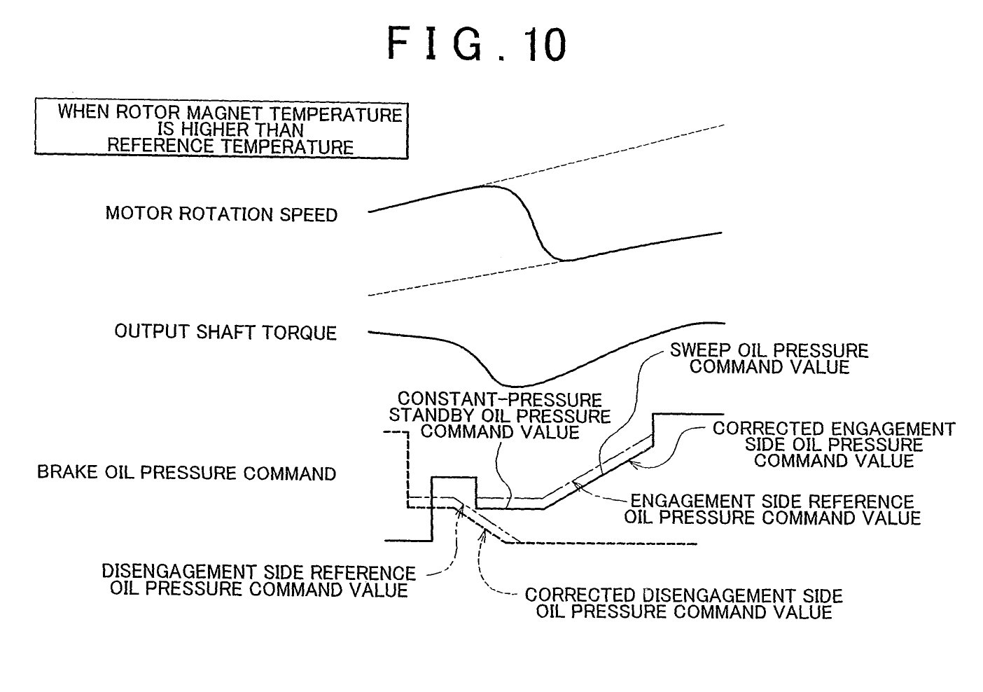

FIG. 10 shows the motor rotation speed, the output shaft torque of the automatic transmission 3, and the brake oil pressure command value (the solid line indicates an oil pressure command value relating to the engagement side brake, while the broken line indicates an oil pressure command value relating to the disengagement side brake) in this case. Further, a dot-dash line in the drawing indicates the oil pressure command value relating to the engagement side brake when the rotor magnet temperature is equal to the reference value, and a dot-dot-dash line indicates the oil pressure command value relating to the disengagement side brake when the rotor magnet temperature is equal to the reference value.

Thus, an operation to engage and disengage the brakes B1, B2 is performed in accordance with a lower brake oil pressure than the brake oil pressure used when the rotor magnet temperature is equal to the reference value. As a result, a tie-up state in the automatic transmission 3 is avoided, and shift shock (tie-up shock) is prevented. Note that in FIG. 10, the respective command values of a constant-pressure standby oil pressure and a sweep oil pressure are both set lower than the reference oil pressure command value as brake oil pressure command values for causing the brakes B1, B2 to engage and disengage. For example, every time the rotor magnet temperature increases by 10 degrees relative to the reference temperature, the command value is corrected such that the constant-pressure standby oil pressure and sweep oil pressure decrease by 5%. The values described above are not limited to this example.

On the other hand, when the rotor magnet temperature is lower than the reference value such that a negative determination is made in the step ST5, the routine advances to a step ST10, where an output torque error (positive side error) is detected by recognizing a temperature-affected divergence amount in the output torque from the relationship between the divergence amount of the actual output torque relative to the command value and the rotor magnet temperature, shown in FIG. 8. The routine then advances to a step ST11, where an actual motor output torque that takes into account this error is calculated. In this case, the actual motor output torque is calculated by adding the divergence amount to the output torque obtained when the rotor magnet temperature is equal to the reference temperature (75° C.).

A brake oil pressure correction amount (positive side correction amount) is determined in a step ST12 in accordance with the calculated actual motor output torque, and in the step ST9, a brake oil pressure command value is output to the hydraulic control circuit 300 to obtain the corrected brake oil pressure, and a clutch-to-clutch shift is performed by engaging and disengaging the brakes B1, B2 in accordance with the brake oil pressure generated in the hydraulic control circuit 300. In other words, a clutch-to-clutch shift is performed by engaging and disengaging the brakes B1, B2 in accordance with a higher brake oil pressure than the brake oil pressure used when the rotor magnet temperature is equal to the reference value.

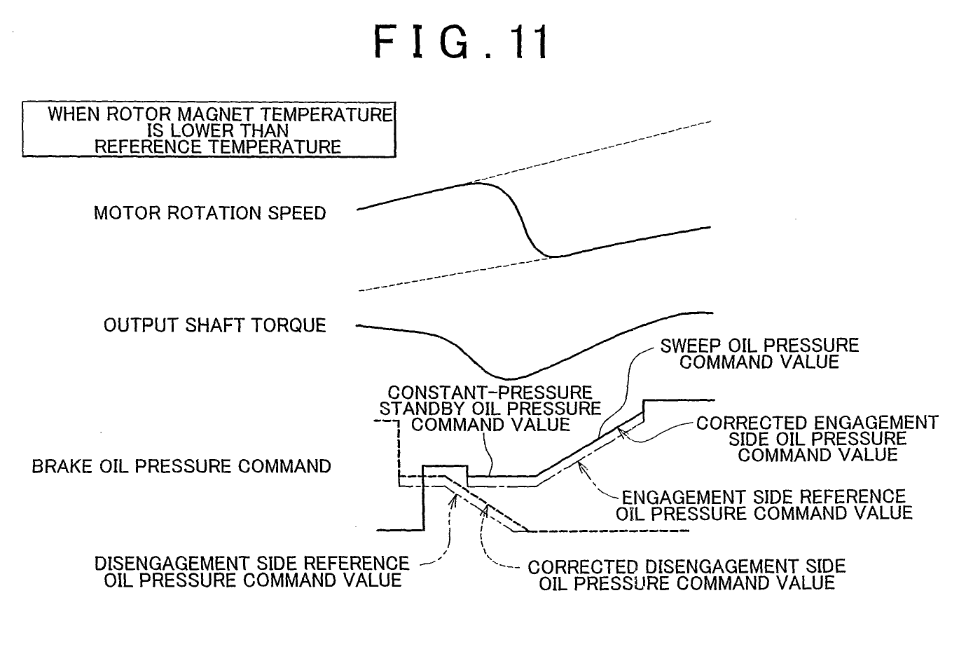

FIG. 11 shows the motor rotation speed, the output shaft torque of the automatic transmission 3, and the brake oil pressure command value (the solid line indicates an oil pressure command value relating to the engagement side brake, while the broken line indicates an oil pressure command value relating to the disengagement side brake) in this case. Further, a dot-dash line in the drawing indicates the oil pressure command value relating to the engagement side brake when the rotor magnet temperature is equal to the reference value, and a dot-dot-dash line indicates the oil pressure command value relating to the disengagement side brake when the rotor magnet temperature is equal to the reference value.

Thus, an operation to engage and disengage the brakes B1, B2 is performed in accordance with a higher brake oil pressure than the brake oil pressure used when the rotor magnet temperature is equal to the reference value. As a result, so-called load slip in the second motor/generator MG2 is avoided, and a situation in which the rotation speed to the second motor/generator MG2 rises rapidly (races) is prevented. Note that in FIG. 11, the respective command values of a constant-pressure standby oil pressure and a sweep oil pressure are both set higher than the reference oil pressure command value as brake oil pressure command values for causing the brakes B1, B2 to engage and disengage. For example, every time the rotor magnet temperature decreases by 10 degrees relative to the reference temperature, the command value is corrected such that the constant-pressure standby oil pressure and sweep oil pressure increase by 5%. The values described above are not limited to this example.

According to the embodiment described above, the torque capacity of the brakes B1, B2 during a shift operation is corrected steadily downward as the rotor magnet temperature of the second motor/generator MG2 increases above the predetermined reference temperature, and conversely, the torque capacity of the brakes B1, B2 during a shift operation is corrected steadily upward as the rotor magnet temperature of the second motor/generator MG2 decreases below the predetermined reference temperature. Thus, the control amount of the shift operation performed in the automatic transmission 3 can be corrected in accordance with variation in the output torque of the second motor/generator MG2 due to the effects of variation in the rotor magnet temperature. As a result, the occurrence of shift shock due to tie-up shock can be prevented. Further, racing of the second motor/generator MG2 can be avoided, the load on a driving part and a sliding part of the second motor/generator MG2 can be lightened, and the life of the second motor/generator MG2 can be extended.

### First Modified Example

Next, a first modified example of the first embodiment will be described. Similarly to the first embodiment, a hybrid vehicle according to this modified example includes two motor/generators, and is structured as an FR (front engine/rear drive) vehicle.

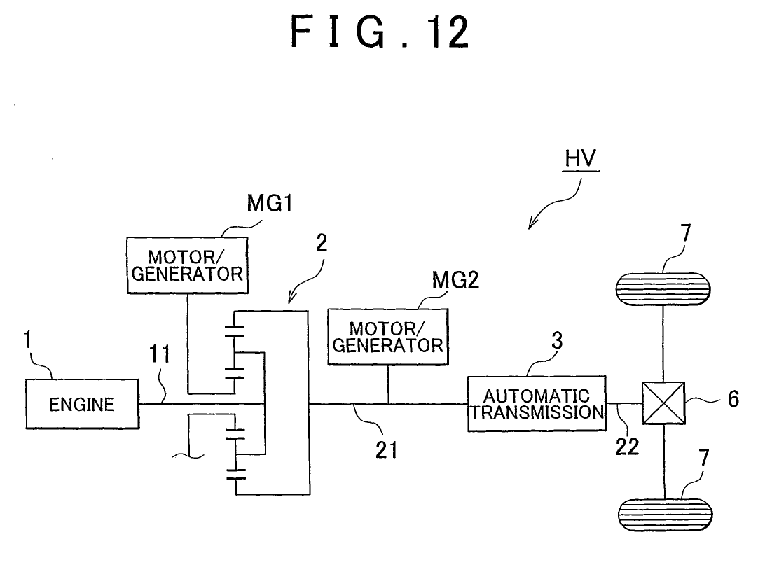

FIG. 12 is a schematic diagram showing the hybrid vehicle HV according to this modified example. In FIG. 12, identical constitutional members to those of the first embodiment have been allocated identical reference symbols, and description thereof has been omitted.

In the hybrid vehicle HV of the first embodiment described above, the rotary shaft of the second motor/generator MG2 is connected to the input shaft 30 of the automatic transmission 3, and the power of the second motor/generator MG2 is output to the ring gear shaft (output shaft) 21 via the automatic transmission 3.

In the hybrid vehicle according to this modified example, on the other hand, the rotary shaft of the second motor/generator MG2 is connected to the ring gear shaft 21, and the power of the engine 1 and the two motor/generators MG1, MG2 is transmitted to the output shaft 22 (the drive wheels 7) via the automatic transmission 3.

The present invention is also applicable to this type of hybrid vehicle HV. More specifically, in this type of hybrid vehicle HV, the torque capacity of the brakes B1, B2 during a shift operation is corrected steadily downward as the rotor magnet temperature of the second motor/generator MG2 increases above the predetermined reference temperature, and conversely, the torque capacity of the brakes B1, B2 during a shift operation is corrected steadily upward as the rotor magnet temperature of the second motor/generator MG2 decreases below the predetermined reference temperature.

Further, with this type of hybrid vehicle HV, the output torque of the first motor/generator MG1 is also input into the automatic transmission 3, and therefore the torque capacity of the brakes B1, B2 is preferably corrected in accordance with the temperature of a rotor magnet provided in the first motor/generator MG1, similarly to the first embodiment.

### Second Modified Example

Next, a second modified example of the first embodiment will be described. In the hybrid vehicle HV according to this modified example, in addition to the control for correcting the torque capacity of the brakes B1, B2 during a shift operation in accordance with the rotor magnet temperature, as in the first embodiment, the torque capacity command values of the brakes B1, B2 during a shift operation are also corrected in accordance with a surface temperature of respective frictional contact surfaces of the brakes B1, B2 (additional correction).

More specifically, when the brakes B1, B2 are engaged and disengaged repeatedly such that the surface temperature of the respective frictional contact surfaces thereof increases due to the effects of frictional heat and so on, frictional resistance upon contact with the frictional contact surface of the partner side decreases in comparison with a case in which the surface temperature is low. As a result, a situation in which the torque capacity of the brakes B1, B2 becomes insufficient relative to the output torque of the second motor/generator MG2 may arise.

In consideration of this type of situation, in this embodiment, the oil pressure command value relating to the hydraulic control circuit 300 is also corrected such that the torque capacity command values of the brakes B1, B2 during a shift operation increase steadily as the surface temperature of the frictional contact surfaces increases above a predetermined reference temperature (50° C., for example). Conversely, the oil pressure command value relating to the hydraulic control circuit 300 is also corrected such that the torque capacity command values of the brakes B1, B2 during a shift operation decrease steadily as the surface temperature of the frictional contact surfaces decreases below the predetermined reference temperature (a torque capacity correction operation performed by an additional correcting portion).

Note that in this modified example, a frictional contact surface temperature estimation map for estimating the surface temperature of the frictional contact surface is stored in the ROM 102 of the ECU 100. The frictional contact surface temperature estimation map shows a relationship between an engagement/disengagement operation history of the brakes B1, B2, for example an engagement/disengagement frequency per unit time, and an increase in the frictional contact surface temperature, and is obtained by plotting values determined empirically through experiment, calculation and so on.

Specifically, in the oil pressure command value correction operation, the surface temperature of the frictional contact surface is estimated in accordance with the aforementioned frictional contact surface estimation map (a surface temperature estimation operation performed by a frictional contact surface temperature recognizing portion), and every time the surface temperature of the frictional contact surface rises by 10 degrees relative to the reference temperature, the command value is corrected such that the constant-pressure standby oil pressure and the sweep oil pressure rise by 2%. Further, every time the surface temperature of the frictional contact surface falls by 10 degrees relative to the reference temperature, the command value is corrected such that the constant-pressure standby oil pressure and the sweep oil pressure fall by 2%. Hence, the effect of temperature variation in the surface temperature of the frictional contact surface on the oil pressure correction amount is set smaller than the effect of variation in the rotor magnet temperature on the oil pressure correction amount. Variation in the surface temperature of the frictional contact surface may occur more rapidly than variation in the rotor magnet temperature, and therefore the former is set smaller than the latter to avoid a situation in which the torque capacity of the brakes B1, B2 varies greatly and rapidly so as to deviate from an appropriate value. The values described above are not limited to this example.

Further, the respective temperatures of the brakes B1, B2 may differ. For example, the surface temperature of the frictional contact surface of the engagement side brake may rise rapidly while the surface temperature of the frictional contact surface of the disengagement side brake rises slowly. In this case, the respective torque capacity correction values of the brakes B1, B2 during a shift operation are preferably varied in accordance with the surface temperatures of the respective frictional contact surfaces.

Note that the technique of the second modified example may be applied to the hybrid vehicle HV according to the first modified example.

### Second Embodiment

Next, a second embodiment will be described. A hybrid vehicle according to this embodiment includes two motor/generators, and is structured as an FF (front engine/front drive) vehicle.

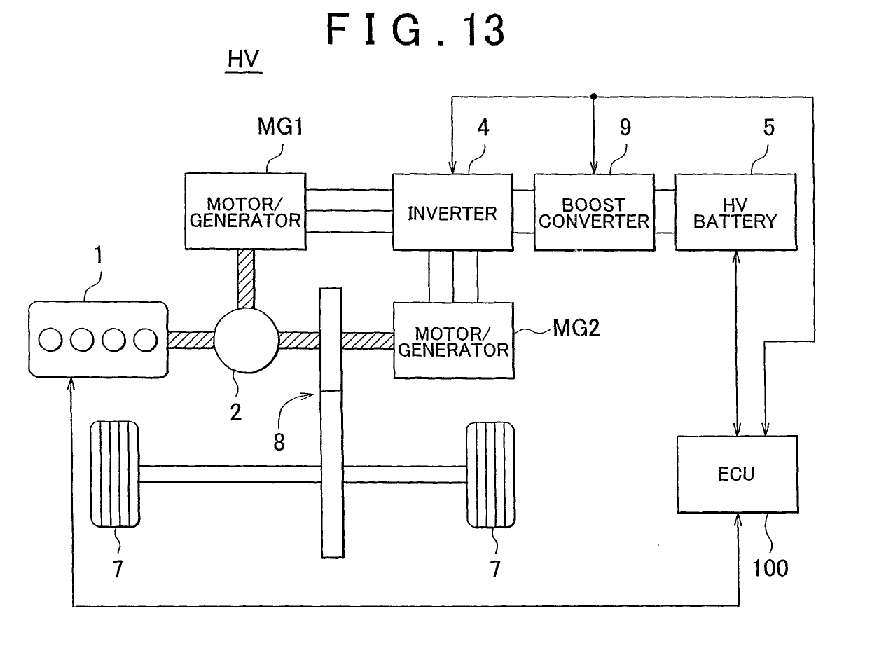

FIG. 13 is a schematic diagram of the hybrid vehicle HV according to this embodiment. This hybrid vehicle HV is constituted by a so-called series/parallel hybrid vehicle. The following brief description of the hybrid vehicle HV will focus on differences with the first embodiment.

The hybrid vehicle HV according to this embodiment also includes the engine 1, the first motor/generator MG1, the second motor/generator MG2, the power distribution mechanism 2, the inverter 4, the HV battery 5, the drive wheels 7, the hydraulic control circuit, the ECU 100, and so on.

Further, the hybrid vehicle HV according to this embodiment does not include an automatic transmission. Instead, the output torque of the engine 1 and the output torque of the second motor/generator MG2, which are transmitted via the power distribution mechanism 2, are output to the drive wheels (front wheels) 7 via a speed reducer 8.

Further, a boost converter 9 is provided between the HV battery 5 and the inverter 4 to boost a battery voltage during power supply to the motor/generators MG1, MG2 from the HV battery 5.

In the hybrid vehicle HV of this embodiment, constituted as described above, a torque command value relating to the first motor/generator MG1 is corrected on the basis of the rotor magnet temperature of the first motor/generator MG1 (a torque command value correction operation performed by a torque command value correcting portion). This operation will be described in detail below.

A condition for setting a pulse signal serving as a torque command value relating to the first motor/generator MG1 is that the rotor magnet temperature reaches 75° C. (a reference temperature). In other words, when the rotor magnet temperature is 75° C., the torque command value is set such that the desired output torque is obtained.

However, the rotor magnet temperature of the first motor/generator MG1 varies constantly in accordance with the use condition and the like of the first motor/generator MG1. When the rotor magnet temperature varies in this manner, the capacity of the first motor/generator MG1 varies in accordance with the rotor magnet temperature. More specifically, when the rotor magnet temperature increases, the actual output torque becomes smaller than the output torque that is originally obtained in accordance with the command value relating to the first motor/generator MG1. Conversely, when the rotor magnet temperature decreases, the actual output torque becomes larger than the output torque that is originally obtained in accordance with the command value relating to the first motor/generator MG1.

In consideration of these circumstances, in this embodiment the pulse signal (torque command value) serving as a command value relating to the first motor/generator MG1 is corrected in accordance with the rotor magnet temperature. More specifically, as the rotor magnet temperature rises relative to the reference temperature, the command value is corrected in a direction for increasing the output torque from the first motor/generator MG1, and conversely, as the rotor magnet temperature decreases relative to the reference temperature, the command value is corrected in a direction for reducing the output torque from the first motor/generator MG1. For example, every time the rotor magnet temperature increases by 10 degrees relative to the reference temperature, the command value is corrected such that the output torque from the first motor/generator MG1 increases by 5%, and conversely, every time the rotor magnet temperature decreases by 10 degrees relative to the reference temperature, the command value is corrected such that the output torque from the first motor/generator MG1 decreases by 5%. The correction amount is not limited to this example, and may be determined empirically through experiment, calculation, and so on, for example, such that an appropriate output torque is obtained without the influence of variation in the rotor magnet temperature.

Note that in this embodiment also, a rotor magnet temperature estimation map for estimating the rotor magnet temperature of the first motor/generator MG1 is stored in the ROM 102 of the ECU 100. The rotor magnet temperature estimation map shows a relationship between a driving history of the first motor/generator MG1, for example a driving rotation speed per unit time, and an increase in the rotor magnet temperature, and is obtained by plotting values determined empirically through experiment, calculation and so on.

Hence, in this embodiment, the torque command value relating to the first motor/generator MG1 is corrected on the basis of the rotor magnet temperature of the first motor/generator MG1, and therefore an appropriate output torque is obtained at all times without the influence of variation in the rotor magnet temperature. As a result, traveling stability in the hybrid vehicle HV and a travel performance that corresponds to a driver request can be obtained.

A similar command value correction operation may be performed on the second motor/generator MG2. More specifically, the command value may be corrected in a direction for increasing the output torque from the second motor/generator MG2 as the rotor magnet temperature rises relative to the reference temperature, and conversely, the command value may be corrected in a direction for reducing the output torque from the second motor/generator MG2 as the rotor magnet temperature falls relative to the reference temperature.

### Third Embodiment

Next, a third embodiment will be described. In this embodiment, the torque capacity of the brakes B1, B2 during a shift operation is corrected in accordance with the temperature of the engine 1.

More specifically, when the temperature of the engine (internal combustion engine) 1 is comparatively low, for example immediately after a cold start, the viscosity of a lubricating oil is high, leading to agitation resistance and so on which tend to cause the output torque to decrease. Following warm-up completion, on the other hand, when the temperature of the engine 1 is comparatively high, the output torque tends to rise due to a reduction in the agitation resistance.

In consideration of these points, in this embodiment the torque capacity of the brakes B1, B2 of the automatic transmission 3 is corrected on the basis of a correlation between the temperature of the engine 1 (a cooling water temperature detected by a cooling water temperature sensor and a lubricating oil temperature detected by an oil temperature sensor) and the output torque.

More specifically, the torque capacity of the brakes B1, B2 during a shift operation is corrected steadily downward as the temperature of the engine 1, determined from the cooling water temperature and the lubricating oil temperature, decreases below a predetermined warm-up operation completion temperature (for example, a cooling water temperature of 50° C.).

On the other hand, as the temperature of the engine 1, determined from the cooling water temperature and the lubricating oil temperature, increases above the predetermined warm-up operation completion temperature, the torque capacity of the brakes B1, B2 during a shift operation is corrected steadily upward.

Hence, in this embodiment, situations in which the torque capacity of the brakes B1, B2 becomes excessive relative to the engine output, leading to tie-up shock, or the torque capacity of the brakes B1, B2 becomes insufficient relative to the engine output, causing the rotation speed of the internal combustion engine to race, can be avoided.

Note that the technique employed in this embodiment, in which the torque capacity of the brakes B1, B2 during a shift operation is corrected in accordance with the temperature of the engine 1, is not limited to the hybrid vehicle HV shown in the embodiments and modified examples described above, and may be applied to a typical vehicle having only the engine 1 as a traveling drive source.

### Fourth Embodiment

Next, a fourth embodiment will be described. In the third embodiment described above, the torque capacity of the brakes B1, B2 during a shift operation is corrected in accordance with the temperature of the engine 1. In this embodiment, on the other hand, the torque capacity of the brakes B1, B2 during a shift operation is corrected in accordance with the temperature of intake air aspirated into the engine 1 (an intake air temperature detected by an intake air temperature sensor).

More specifically, as the intake air temperature falls in the engine (internal combustion engine) 1, the efficiency with which air is charged into a cylinder steadily increases, leading to an increase in the output torque. Conversely, as the intake air temperature rises, the air charging efficiency steadily decreases, leading to a reduction in output torque.

In consideration of this point, in this embodiment the torque capacity of the brakes B1, B2 is corrected on the basis of a correlation between the temperature of the intake air aspirated into the engine 1 and the output torque.

More specifically, the torque capacity of the brakes B1, B2 during a shift operation is corrected steadily upward as the intake air temperature falls below a predetermined reference temperature (20° C., for example).

As the intake air temperature increases above the predetermined reference temperature, on the other hand, the torque capacity of the brakes B1, B2 during a shift operation is corrected steadily downward.

Hence, in this embodiment also, situations in which the torque capacity of the brakes B1, B2 becomes excessive relative to the engine output, leading to tie-up shock, or the torque capacity of the brakes B1, B2 becomes insufficient relative to the engine output, causing the rotation speed of the internal combustion engine to race, can be avoided.

Note that the technique employed in this embodiment, in which the torque capacity of the brakes B1, B2 during a shift operation is corrected in accordance with the intake air temperature of the engine 1, is also not limited to the hybrid vehicle HV shown in the embodiments and modified examples described above, and may be applied to a typical vehicle having only the engine 1 as a traveling drive source.

### Other Embodiments

In each of the embodiments and modified examples described above, the present invention is applied to the hybrid vehicle HV installed with the two motor/generators MG1, MG2, but the present invention is not limited thereto, and may also be applied to a hybrid vehicle installed with a single motor/generator or three or more motor/generators.

Further, in the first and second embodiments and the modified examples, the temperature of the motor/generators MG1, MG2 is estimated from the operating history thereof and so on, but the temperature may be detected directly using a temperature sensor or the like. In this case, it is difficult to bring a temperature sensor into direct contact with the rotor magnet (rotary body) of the motor/generators MG1, MG2, and therefore a temperature sensor is attached to a stator side, for example, and the rotor magnet temperature is estimated from the temperature detected thereby. Further, an alternating current synchronous motor is employed as the motor/generators MG1, MG2, but an induction-type motor may be applied.

Further, in each of the embodiments and modified examples described above, the frictional engagement elements of the automatic transmission 3 are constituted by the hydraulic brakes B1, B2, but the present invention is also applicable to a case in which the frictional engagement elements are constituted by electromagnetic clutches. In this case, engagement and disengagement are performed by duty-controlling a pulse signal applied to the electromagnetic clutches, for example, and the engagement and disengagement operations are controlled by correcting a duty ratio thereof. More specifically, when the torque capacity of the electromagnetic clutches is to be increased, for example, the duty ratio is corrected in an increasing direction, and when the torque capacity of the electromagnetic clutches is to be reduced, the duty ratio is corrected in a decreasing direction.

Further, in each of the embodiments and modified examples described above, the present invention is applied to a vehicle having the two-forward speed automatic transmission 3. However, the present invention is not limited thereto, and may be applied to a vehicle installed with a planetary gear-type automatic transmission having any other number of shift stages.

Further, in each of the embodiments and modified examples described above, the present invention is applied to the hybrid vehicle HV installed with an engine (the internal combustion engine 1) and an electric motor (the motor/generators) MG1, MG2 as drive sources, but the present invention is not limited thereto, and in the first and second embodiments and the modified examples, the present invention may be applied to an electric vehicle (EV) installed with only an electric motor (a motor/generator or a motor) as a drive source.

1. A control device for a vehicle, comprising:
an electric motor that outputs a driving force for travel;
a transmission that is provided on a power transmission path extending from the electric motor to a drive wheel and performs a shift operation by modifying an engagement state of a frictional engagement element;
a transmission control portion that controls the shift operation of the transmission;
a temperature recognizing portion that estimates or detects a temperature of the electric motor; and
a shift operation correcting portion that corrects a control amount of the shift operation performed in the transmission by the transmission control portion, on the basis of the temperature of the electric motor estimated or detected by the temperature recognizing portion.

2. The control device according to claim 1, wherein the temperature recognizing portion estimates or detects a temperature of a magnet provided in the electric motor.

3. The control device according to claim 1, wherein the shift operation correcting portion corrects a torque capacity of the frictional engagement element during modification of the engagement state of the frictional engagement element.

4. The control device according to claim 3, wherein the shift operation correcting portion corrects the torque capacity of the frictional engagement element during modification of the engagement state of the frictional engagement element such that the torque capacity decreases as the temperature of the electric motor, estimated or detected by the temperature recognizing portion, increases above a predetermined reference temperature.

5. The control device according to claim 3, wherein the shift operating correcting portion corrects the torque capacity of the frictional engagement element during modification of the engagement state of the frictional engagement element such that the torque capacity increases as the temperature of the electric motor, estimated or detected by the temperature recognizing portion, decreases below a predetermined reference temperature.

6. The control device according to claim 4, wherein the engagement state of the frictional engagement element is modified by a supply of oil pressure, and
the shift operation correcting portion reduces the torque capacity of the frictional engagement element by correcting an oil pressure value supplied to the frictional engagement element in a decreasing direction.

7. The control device according to claim 5, wherein the engagement state of the frictional engagement element is modified by a supply of oil pressure, and
the shift operation correcting portion increases the torque capacity of the frictional engagement element by correcting an oil pressure value supplied to the frictional engagement element in an increasing direction.

8. The control device according to claim 3, wherein the frictional engagement element is constituted by an electromagnetic clutch, and
the shift operation correcting portion corrects the torque capacity of the frictional engagement element by correcting a voltage value for activating the electromagnetic clutch.

9. The control device according to claim 3, further comprising:
a frictional contact surface temperature recognizing portion that estimates or detects a surface temperature of a frictional contact surface of the frictional engagement element; and
a shift operation additional correcting portion that corrects a command value of the torque capacity of the frictional engagement element during modification of the engagement state of the frictional engagement element such that the command value increases as the surface temperature of the frictional contact surface, estimated or detected by the frictional contact surface temperature recognizing portion, increases above a predetermined reference temperature.

10. The control device according to claim 3, further comprising:
a frictional contact surface temperature recognizing portion that estimates or detects a surface temperature of a frictional contact surface of the frictional engagement element; and
a shift operation additional correcting portion that corrects a command value of the torque capacity of the frictional engagement element during modification of the engagement state of the frictional engagement element such that the command value decreases as the surface temperature of the frictional contact surface, estimated or detected by the frictional contact surface temperature recognizing portion, decreases below a predetermined reference temperature.

11. A control device for a vehicle, comprising:
a drive source that outputs a driving force for travel;
a transmission that is provided on a power transmission path extending from the drive source to a drive wheel and performs a shift operation by modifying an engagement state of a frictional engagement element;
a transmission control portion that controls the shift operation of the transmission;
a temperature recognizing portion that estimates or detects a temperature of the drive source; and
a shift operation correcting portion that corrects a control amount of the shift operation performed in the transmission by the transmission control portion, on the basis of the temperature of the drive source estimated or detected by the temperature recognizing portion.

12. The control device according to claim 11, wherein the drive source is an internal combustion engine, and
the temperature recognizing portion detects a cooling water temperature or a lubricating oil temperature of the internal combustion engine.

13. The control device according to claim 11, wherein the drive source is an internal combustion engine, and
the shift operation correcting portion corrects a torque capacity of the frictional engagement element during modification of the engagement state of the frictional engagement element such that the torque capacity decreases as the temperature of the internal combustion engine, estimated or detected by the temperature recognizing portion, decreases below a predetermined warm-up operation completion temperature.

14. The control device according to claim 11, wherein the drive source is an internal combustion engine, and
the shift operation correcting portion corrects a torque capacity of the frictional engagement element during modification of the engagement state of the frictional engagement element such that the torque capacity increases as the temperature of the internal combustion engine, estimated or detected by the temperature recognizing portion, increases above a predetermined warm-up operation completion temperature.

15. A control device for a vehicle, comprising:
an internal combustion engine that outputs a driving force for travel;
a transmission that is provided on a power transmission path extending from the internal combustion engine to a drive wheel and performs a shift operation by modifying an engagement state of a frictional engagement element;
a transmission control portion that controls the shift operation of the transmission;
a temperature recognizing portion that detects a temperature of intake air aspirated into the internal combustion engine; and
a shift operation correcting portion that corrects a control amount of the shift operation performed in the transmission by the transmission control portion, on the basis of the temperature of the intake air detected by the temperature recognizing portion.

16. The control device according to claim 15, wherein the shift operation correcting portion corrects a torque capacity of the frictional engagement element during modification of the engagement state of the frictional engagement element such that the torque capacity decreases as the temperature of the intake air detected by the temperature recognizing portion increases above a predetermined temperature.

17. The control device according to claim 15, wherein the shift operation correcting portion corrects a torque capacity of the frictional engagement element during modification of the engagement state of the frictional engagement element such that the torque capacity increases as the temperature of the intake air detected by the temperature recognizing portion decreases below a predetermined temperature.

18. A control device for a vehicle, comprising:
an electric motor that outputs a driving force for travel;
an electric motor control portion that drive-controls the electric motor by outputting a torque command value to the electric motor;
a temperature recognizing portion that estimates or detects a temperature of the electric motor; and
a torque command value correcting portion that corrects the torque command value output by the electric motor control portion, on the basis of the temperature of the electric motor estimated or detected by the temperature recognizing portion.

19. The control device according to claim 18, wherein the torque command value correcting portion corrects the torque command value such that the torque command value increases as the temperature of the electric motor estimated or detected by the temperature recognizing portion increases above a predetermined temperature.

20. The control device according to claim 19, wherein the torque command value correcting portion corrects the torque command value such that the torque command value decreases as the temperature of the electric motor estimated or detected by the temperature recognizing portion decreases below the predetermined temperature.
